(19) United States
(12) Patent Application Publication
(10) Pub. No.: US 2024/0196000 A1
(43) Pub. Date: Jun. 13, 2024

(54) VIDEO DISTRIBUTION APPARATUS, VIDEO RECEPTION APPARATUS, CONTROL METHODS THEREFOR, AND NON-TRANSITORY COMPUTER-READABLE STORAGE MEDIUM

(71) Applicant: CANON KABUSHIKI KAISHA, Tokyo (JP)

(72) Inventors: KIYOSHI IWABUCHI, Tokyo (JP); KOJI OKAWA, Tokyo (JP)

(21) Appl. No.: 18/493,874

(22) Filed: Oct. 25, 2023

(30) Foreign Application Priority Data
Dec. 8, 2022 (JP) 2022-196562

(51) Int. Cl. H04N 19/46; G06V 20/40; H04N 19/142; H04N 19/167; H04N 19/172; H04N 19/177; H04N 19/23

(52) U.S. Cl. CPC H04N 19/46; G06V 20/41; H04N 19/142; H04N 19/167; H04N 19/172; H04N 19/177; H04N 19/23; G06V 2201/10

(57) ABSTRACT

A video distribution apparatus includes an object detection unit configured to execute object detection processing with respect to a video indicated by video data obtained by the image capturing unit; metadata addition unit configured to add information related to an object obtained by the object detection unit, as metadata, to encoded data of a corresponding frame of the video, and a control unit configured to control the metadata addition unit based on a result of the detection processing executed by the object detection unit, wherein in a case where the result of the detection processing executed by the object detection unit indicates a disappearance of the object, the control unit controls the metadata addition unit to add metadata indicating the disappearance of the object also to a frame that follows the corresponding frame and satisfies a predetermined condition.

### CROSS-REFERENCE TO PRIORITY APPLICATION

This application claims the benefit of Japanese Patent Application No. 2022-196562, filed Dec. 8, 2022, which is hereby incorporated by reference herein in its entirety.

### BACKGROUND OF THE INVENTION

### Field of the Invention

The present invention relates to a video distribution technique, and especially to a video distribution technique based on metadata related to an object.

### Description of the Related Art

A system has become widespread in which a video transmission server detects an object in an image using a video content analysis (VCA) function, generates metadata related to the object, and transmits the metadata to a video request source (a client apparatus) that displays a received video.

An annotated region SEI message (hereafter, ARSEI) according to H.265 has been known as a format of metadata. With ARSEI, information related to an object can be represented by using a label indicating a type of the object or a bounding box indicating a position of the object.

A client apparatus that has received a video having ARSEI added thereto can utilize the same to display a frame of an object or display label information. Furthermore, with ARSEI, labels and position information can be omitted with respect to frames that exhibit no change, for the purpose of reduction of a data amount.

In video transmission, a phenomenon called “a lack of frames (also called frame drops)” may occur in which an error in a transmission path causes a lack of information, thereby causing a lack of video on a per-frame basis on a video receiving side because the video cannot be reproduced.

Japanese Patent No. 4898177 discloses a technique to detect that data pieces have become discontinuous or the number of data pieces has become smaller than a predetermined number, and provide a notification indicating such a status.

However, the technique disclosed in Japanese Patent No. 4898177 merely detects an error and provides a notification indicating the error, and does not take prevention of a lack of information into consideration.

Therefore, if the “lack of frames” phenomenon occurs in transmission of a video having ARSEI added thereto, for example, when there is a lack of information indicating that an object has disappeared, a problem occurs in which erroneous information, such as a frame or label information of the object, is continuously displayed on the video even though the object no longer exists.

### SUMMARY OF THE INVENTION

The present invention has been made in view of the above-described problem, and aims to provide a technique to suppress the occurrence of a problem in which information related to an object that no longer exists is continuously displayed even if a frame drop has occurred.

To solve the problem, for example, a video distribution apparatus including image capturing unit, encoding unit configured to encode video data obtained by the image capturing unit, and communication unit configured to transmit the encoded video data obtained by the encoding unit to a reception apparatus in a network, the video distribution apparatus comprising: object detection unit configured to execute object detection processing with respect to a video indicated by video data obtained by the image capturing unit; metadata addition unit configured to add information related to an object obtained by the object detection unit, as metadata, to encoded data of a corresponding frame of the video; and control unit configured to control the metadata addition unit based on a result of the detection processing executed by the object detection unit, wherein in a case where the result of the detection processing executed by the object detection unit indicates a disappearance of the object, the control unit controls the metadata addition unit to add metadata indicating the disappearance of the object also to a frame that follows the corresponding frame and satisfies a predetermined condition.

Further features of the present invention will become apparent from the following description of exemplary embodiments (with reference to the attached drawings).

### BRIEF DESCRIPTION OF THE DRAWINGS

FIG. 1 is a block configuration diagram of an information generation apparatus according to a first embodiment.

FIG. 2A is a diagram showing a first part of a data structure of ARSEI used in the first embodiment.

FIG. 2B is a diagram showing a second part of a data structure of ARSEI used in the first embodiment.

FIG. 2C is a diagram showing an end part of a data structure of ARSEI used in the first embodiment.

FIG. 3 is a diagram showing a part of the data structure of ARSEI used in the first embodiment.

FIG. 4 is a diagram showing a part of the data structure of ARSEI used in the first embodiment.

FIG. 5 is a flowchart showing video transmission processing according to the first embodiment.

FIG. 6 is a flowchart showing video reception processing according to the first embodiment.

FIG. 7 is a flowchart showing video transmission processing according to a second embodiment.

FIG. 8 is a flowchart showing video reception processing according to the second embodiment.

FIG. 9 is a block configuration diagram of a client apparatus according to an embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

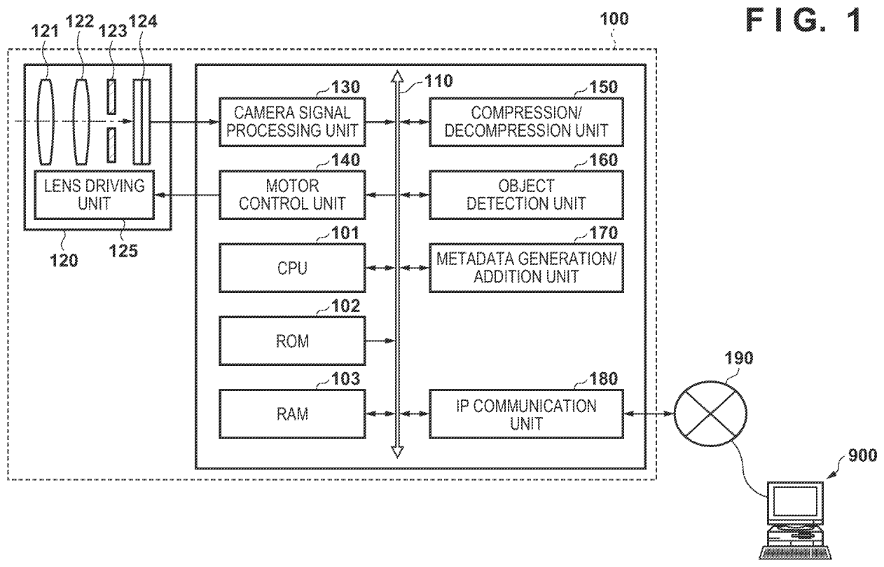

FIG. 1 is a block configuration diagram of a video distribution apparatus 100 to which a first embodiment is applied. Understanding is made easy by considering that the video distribution apparatus 100 is applied to, for example, a surveillance camera that distributes a shot live video to a client apparatus 900 that requests a video.

A CPU 101 is a central processing unit. A ROM 102 is a nonvolatile memory such as an EEPROM and a flash memory. A RAM 103 is a volatile memory such as an SRAM and a DRAM.

A program for realizing the functions pertaining to the present embodiment, as well as data that is used when this program is executed, is stored in the ROM 102. Under control of the central processing unit (CPU) 101, these program and data are loaded to the RAM 103 via a bus 110 as appropriate, and executed by the central processing unit (CPU) 101.

An image capturing unit 120 includes a zoom lens 121, a focus lens 122, a diaphragm 123, an image capturing element 124 composed of an image sensor and the like, and a lens driving unit 125. The zoom lens 121 is driven by the lens driving unit 125 to move along the optical axis. Similarly, the focus lens 122 is driven by the lens driving unit 125 to move along the optical axis. The diaphragm 123 is driven by the lens driving unit 125 to change an area through which light is transmitted. The image capturing element 124 generates analog image signals by photoelectrically converting light that has been transmitted through the zoom lens 121, the focus lens 122, and the diaphragm 123. The image capturing unit 120 applies amplification processing based on sampling processing such as correlated double sampling to the analog image signals obtained by the image capturing element 124, and then supplies the analog image signals to a camera signal processing unit 130.

The camera signal processing unit 130 includes an A/D converter built therein. Then, after converting the analog image signals from the image capturing unit 120 into digital image signals using the A/D converter, the camera signal processing unit 130 applies various types of digital image processing to the digital image signals. Various types of digital image processing include, for example, offset processing, gamma correction processing, gain processing, RGB interpolation processing, noise reduction processing, outline correction processing, tone correction processing, light source type determination processing, and so forth. The camera signal processing unit 130 stores a video (image data) after such digital image processing into the RAM 103 via the bus 110.

Under control of the CPU 101, a motor control unit 140 generates signals for controlling the lens driving unit 125.

Under control of the CPU 101, a compression/decompression unit 150 applies compression/encoding processing to the video that has been stored into the RAM 103 by the camera signal processing unit 130, and stores obtained encoded data into the RAM 103. Furthermore, under control of the CPU 101, the compression/decompression unit 150 can also generate video data by applying decompression processing (decoding processing) to the encoded data stored in the RAM 103, output the video data to a non-illustrated display unit, and cause the video data to be displayed as a video.

An object detection unit 160 receives, as an input, the video that has been stored into the RAM 103 by the camera signal processing unit 130, and executes object detection processing. The object detection unit 160 analyzes an input image and outputs, as object detection information, information indicating the position and type of an object, that is to say, what type of object exists at which location in the image. The object detection information may include a variety of feature amounts such as the size, color, shape, movement, age, and sex of the object, in addition to the position and type of the object. Furthermore, the object detection information also includes position update information of an object that has moved with time, and non-existence information of an object that no longer exists on a screen.

A metadata generation/addition unit 170 receives, as an input, the object detection information which is the result of detection by the object detection unit 160, and generates metadata that has a predetermined format. For example, ARSEI according to H.265 can be used as the format of the metadata. Note that the format of the metadata is not limited to this. Furthermore, when an object has become non-existent, the metadata generation/addition unit 170 can also generate meta information that cancels generated metadata that has been stored in the RAM 103. Generated metadata is added to compressed encoded data that has been stored into the RAM 103 as an output from the compression/decompression unit 150, and stored into the RAM 103.

An IP communication unit 180 is connected to a network 190 via a LAN. This IP communication unit 180 distributes, to the client apparatus 900 in the network, encoded video data which has been stored in the RAM 103 and to which metadata has been added. Note that connection between the IP communication unit 180 and the network 190 may be either wired or wireless.

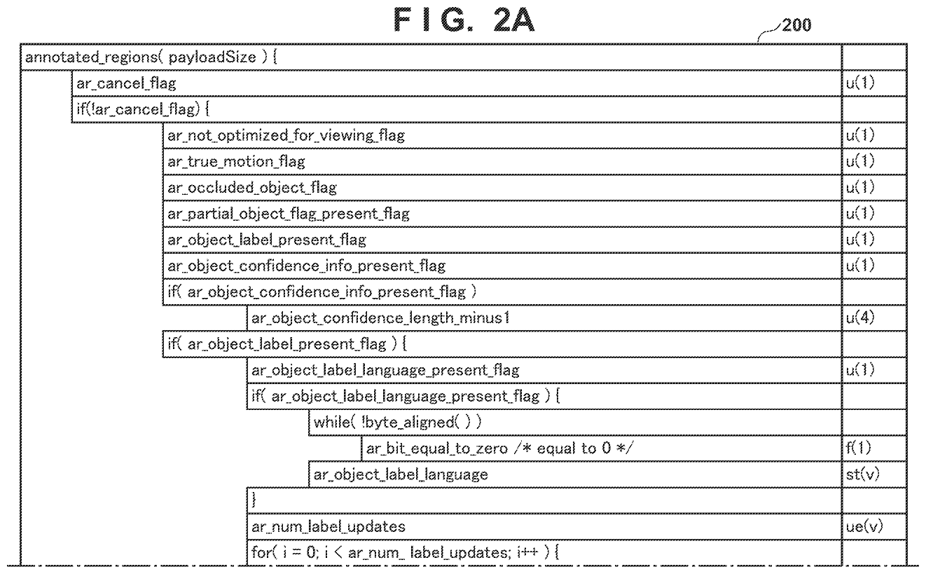

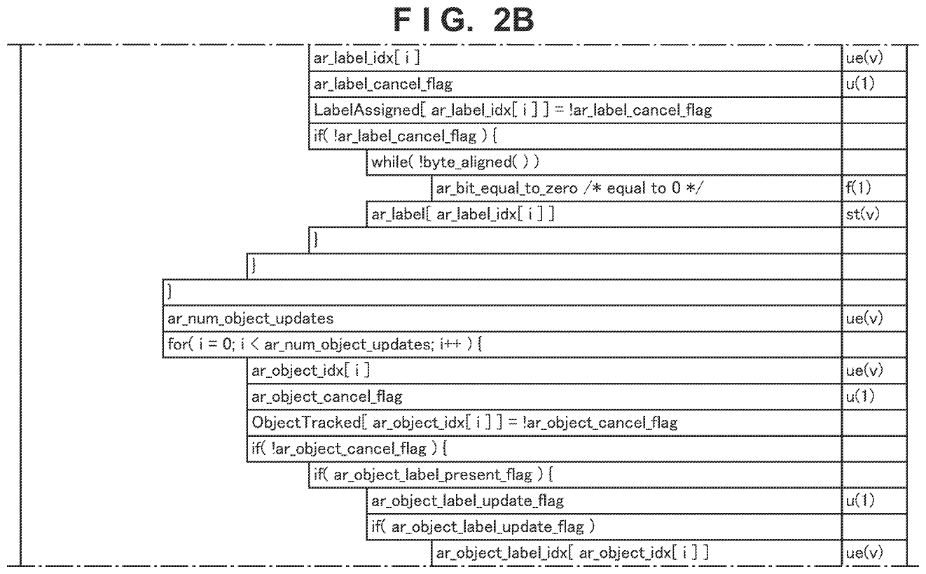

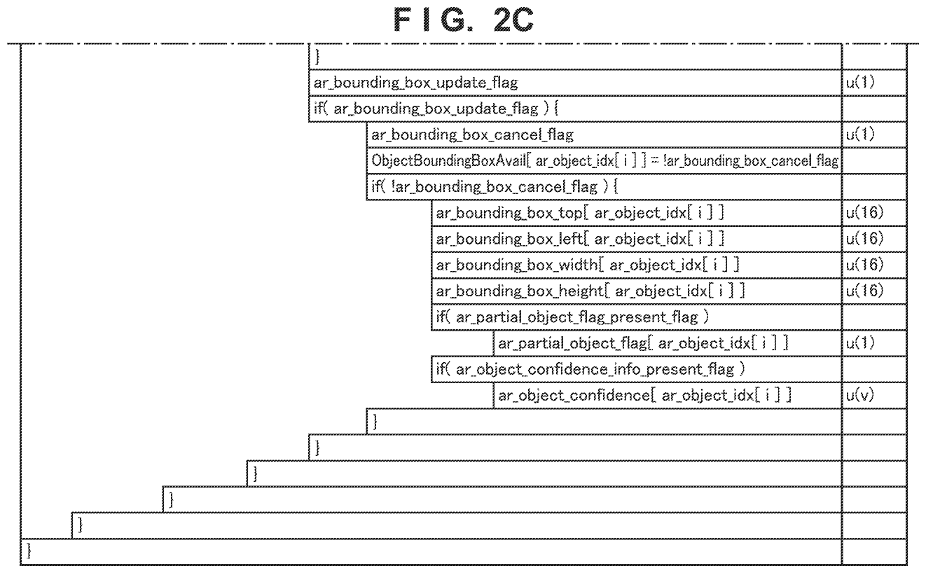

FIG. 2 is an example of a structure of metadata generated by the metadata generation/addition unit 170. In the present embodiment, it is assumed that the format of the metadata is ARSEI according to H.265. The metadata has a data structure indicated by reference sign 200 in FIG. 2, and data can be formed by selecting whether to insert various types of object information into the metadata with use of various types of flags in the data structure.

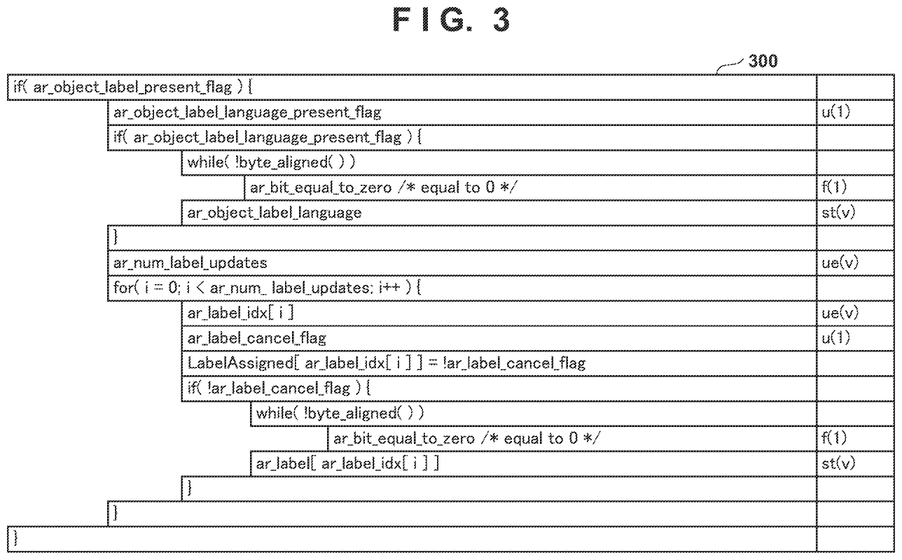

Reference sign 300 shown in FIG. 3 is object information which is a part of the metadata 200 and which is rendered valid by setting a variable ar_object_label_present_flag at “1”. The object information 300 enables notification of information of the types (labels) of objects that can exist in an image to the client apparatus 900 (video reception apparatus).

Specifically, the metadata generation/addition unit 170 first inserts the number of labels to be updated/notified with respect to the client apparatus 900 into a variable ar_num_label_updates in the object information 300. Next, the metadata generation/addition unit 170 inserts identification numbers of labels that correspond in number to the number indicated by the variable ar_num_label_updates into ar_label_idx[i]. Furthermore, the metadata generation/addition unit 170 inserts label names corresponding to the identification numbers of the respective labels into a variable ar_label[ar_label_idx[i]]. Using the metadata 200 including such object information 300, the video distribution apparatus 100 can notify the client apparatus 900 of information of labels of objects that can exist in the image.

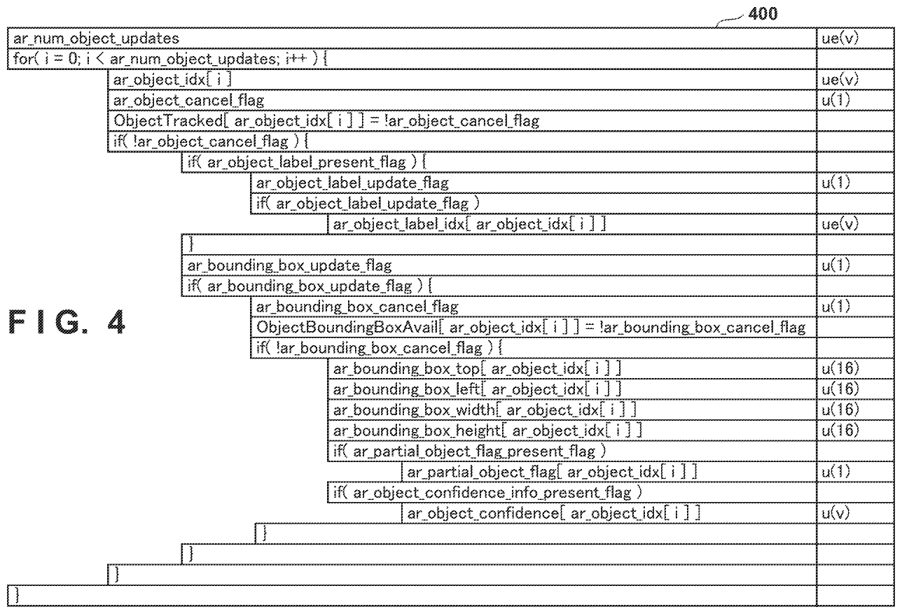

Reference sign 400 shown in FIG. 4 is object information which is a part of the metadata 200 and which is rendered valid by setting a variable ar_num_object_updates at a non-zero value. This object information 400 enables notification of label names corresponding to the respective objects that exist in the image, as well as regions in which these objects exist, to the client apparatus 900.

Specifically, the metadata generation/addition unit 170 first inserts the number of objects to be updated/notified with respect to the client apparatus 900 into a variable ar_num_object_updates in the object information 400. Next, the metadata generation/addition unit 170 inserts identification numbers of objects that correspond in number to the number indicated by the variable ar_num_object_updates into a variable ar_object_idx[i]. Next, after setting a variable ar_object_label_update_flag at “1” in correspondence with the number indicated by the variable ar_num_object_updates, the metadata generation/addition unit 170 selects an identification number corresponding to each object that exists in the image from among the identification numbers of labels inserted in the above-described object information 300, and inserts the selected identification number into a variable ar_object_label_idx[ar_object_idx[i]]. Furthermore, the metadata generation/addition unit 170 inserts values that specify a rectangular region in which each object exists into a variable ar_bounding_box_top[ar_object_idx[i]], a variable ar_bounding_box_left[ar_object_idx[i]], a variable ar_bounding_box_width[ar_object_idx[i]], and a variable ar_bounding_box_height [ar_object_idx[i]].

Here, the variables ar_bounding_box_top[ar_object_idx[i]] and ar_bounding_box_left [ar_object_idx[i]] hold coordinate values of an upper left corner of the rectangular region. Also, the variables ar_bounding_box_width[ar_object_idx[i]] and ar_bounding_box_height[ar_object_idx[i]] hold values indicating the width and height of the rectangular region.

The above-described update/notification based on object information makes it possible to add information pieces in connection with label names of objects that can exist in an image, labels lames corresponding to objects that actually exist in the image, and regions of the objects that exist in the image. Meanwhile, regarding these information pieces, each information piece that has already been added can be deleted by setting the variable ar_label_cancel_flag, ar_object_cancel_flag, or ar_bounding_box_cancel_flag at “1”.

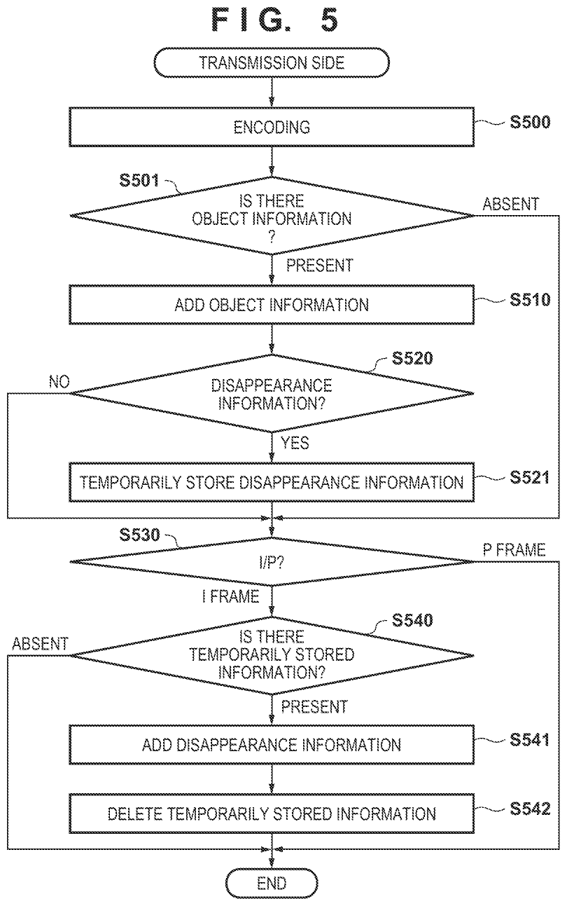

FIG. 5 is a flowchart showing a flow of video distribution control of the video distribution apparatus 100. The following describes video distribution processing of the CPU 101 in the video distribution apparatus 100 with reference to this figure. Note that the description is provided under the assumption that communication connection between the video distribution apparatus 100 and the client apparatus 900 (an apparatus that requests and displays a video) has already been established. To simplify the description, the description is provided under the assumption that the image capturing unit 120 of the video distribution apparatus 100 in the embodiment performs image capture at 30 frames per second, and 1 Group of Pictures (GOP) is composed of 15 frames that are encoded in such a manner that, among these, 1 frame acts as an I frame and the remaining 14 frames act as P frames. That is to say, 1 GOP corresponds to 0.5 seconds.

In step S500, the CPU 101 controls the compression/decompression unit 150 to encode a current frame that has been obtained through image capture. In the embodiment, it is assumed that 15 frames are encoded in such a manner that one of them acts as an I frame (I picture) and the remaining 14 frames act as P frames, and this encoding is performed cyclically, as described above.

In step S501, the CPU 101 checks whether there is object detection information, which is the result of detection by the object detection unit 160. Then, in a case where the CPU 101 has determined that there is object detection information, that is to say, determined that the object detection unit 160 has detected some sort of state change related to an object, processing proceeds to step S510. On the other hand, in a case where the CPU 101 has determined that there is no object detection information, processing proceeds to step S530.

In step S510, the CPU 101 controls the metadata generation/addition unit 170 to convert the object detection information into metadata, and adds the metadata obtained through the conversion to compressed data of a video obtained by the compression/decompression unit 150.

In step S520, the CPU 101 checks whether the added information is disappearance information of an object. Typical examples of a disappearance of an object include, for instance, a movement of an object that has existed up until that point to the outside of the field of view of the image capturing unit 120, blocking of an object by another object, and so forth. In a case where the CPU 101 has determined that the added information is disappearance information of an object, processing proceeds to step S521; otherwise (e.g., an appearance or a positional change of an object), processing proceeds to step S530. In this step S521, the CPU 101 temporarily stores metadata of the disappearance information into the RAM 103. According to ARSEI, deleted information is data of ar_object_cancel_flag for which “1” is written.

In step S530, the CPU 101 checks whether the current encoded compressed image data of the video is an I frame or a P frame. In a case where the CPU 101 has determined that the current frame is an I frame, processing proceeds to step S540; in a case where the current frame has been determined to be other than an I frame, the present processing ends.

In step S540, the CPU 101 checks whether disappearance information of an object was temporarily stored in step S521 at the time of or after a previous I frame. In a case where the CPU 101 has determined that disappearance information was temporarily stored, that is to say, in a case where an object has disappeared in a period between an immediately preceding I frame and the current I frame, the following processing of steps S541 and S542 is executed.

In step S541, the CPU 101 adds the entire metadata of the object disappearance that was temporarily stored in step S521 to the current frame, namely, I frame. This enables re-transmission of the disappearance information that was added to the previous frame. Then, the CPU 101 deletes data of the disappearance information that was temporarily stored in step S542.

To further describe the foregoing, in the case of the embodiment, when a disappearance of an object has been detected at a certain timing, metadata of the object disappearance is added to a frame of that timing, and in addition, the metadata of the object disappearance is added also to the following I frame. Then, in a case where the following I frame has been transmitted with the metadata of the object disappearance added thereto, the metadata of the disappearance of the target object is not added thereafter. As a result, even if an error has occurred in the reception of the frame at the time of the disappearance of the object, the client apparatus 900 can be informed of the disappearance of the target object at least using the subsequent I frame. That is to say, even if a frame of disappeared object is displayed, the period thereof can be set at the period of 1 GOP at the longest.

Note that although the metadata of the disappeared object is re-transmitted only once in the above-described example, it may be re-transmitted multiple times to increase resistance to errors.

Furthermore, while the following describes the client apparatus 900 of the embodiment, the client apparatus 900 of the embodiment discards frames until the next I frame in a case where a reception error has occurred, and therefore does not erroneously display object frames.

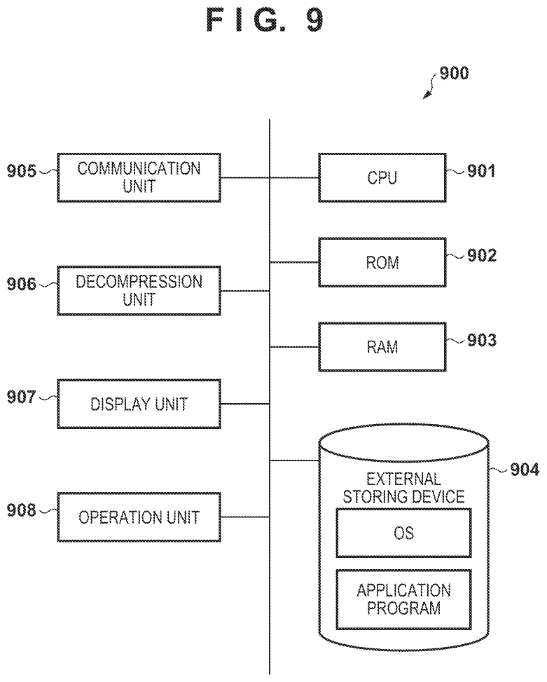

FIG. 9 is a block configuration diagram of the client apparatus 900 in the embodiment. This client apparatus 900 has a function of communicating with the network 190, and receives and displays a video from the above-described video distribution apparatus 100. Typically, the client apparatus 900 is a terminal apparatus such as a personal computer and a smartphone, and basically includes a CPU 901, a ROM 902, a RAM 903, an external storage apparatus 904, a communication unit 905, a decompression unit 906, a display unit 907, and an operation unit 908.

When the power of this apparatus is turned ON, the CPU 901 loads an operating system (OS) from the external storage apparatus 904 to the RAM 903 in accordance with a boot program stored in the ROM 902; consequently, the display unit 907 and the operation unit 908 function as user interfaces. When a user has input an instruction for activating an application related to video reception by operating the user interfaces, the CPU 901 loads a corresponding application for requesting, receiving, and displaying a video from the external storage apparatus 904, which is typically a storage apparatus such as a hard disk, to the RAM 903, and executes this application under the OS. As a result, the communication unit 905 issues a request for transmission of a video to the video distribution apparatus 100 via the network 190, and this apparatus accordingly functions as the client apparatus 900 that displays a video based on received video data.

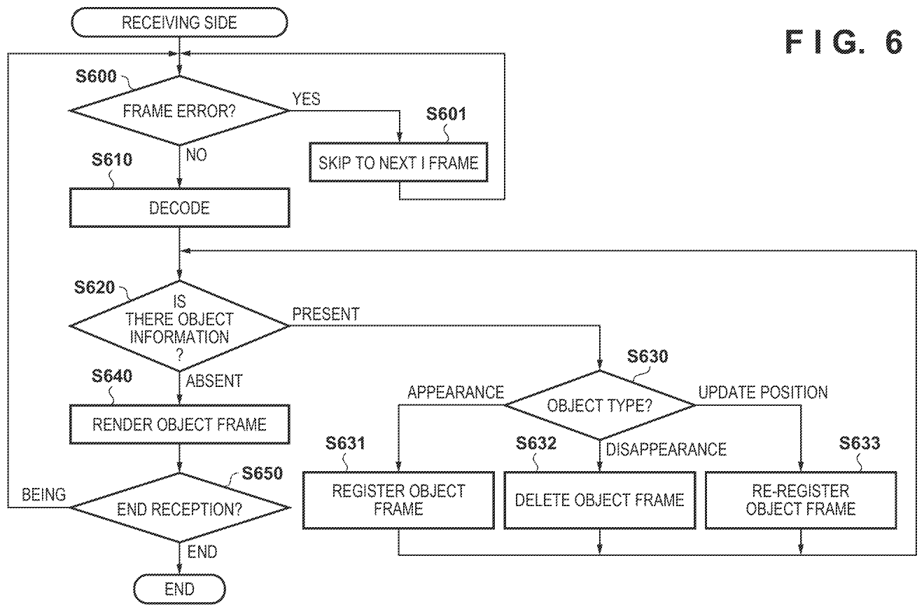

The following describes reception processing of the client apparatus 900 with reference to a flowchart of FIG. 6. Note that the description is provided under the assumption that communication connection with the video distribution apparatus 100 has already been established.

In step S600, the CPU 901 checks whether there is an error in frame data due to a trouble in a communication path. Specifically, the CPU 901 makes this determination, for example, by checking a checksum of the received data, or based on a decoding error in a video.

In a case where the CPU 901 has determined that there is an error in the received frame data in step S600, processing proceeds to step S601. In step S601, the CPU 901 skips to reception of the first I frame that follows the current frame. That is to say, the CPU 901 discards received data from the current frame, which exhibits a frame error, to a frame that immediately precedes the next I frame. This is because, in a case where there is an error in the current frame data, this frame cannot be decoded. Furthermore, as the subsequent P frames have been encoded with reference to the current frame, these subsequent frames cannot be properly decoded, either.

On the other hand, in a case where the CPU 901 has determined that there is no error in the frame data in step S600, processing proceeds to step S610. In step S610, the CPU 901 controls the decompression unit 906 to execute decompression (decoding) processing with respect to the received frame, and display an obtained frame image on the display unit 907.

In step S620, the CPU 901 determines whether metadata of object information has been added to the received frame. Processing is branched to step S630 in a case where the CPU 901 has determined that the metadata has been added, and to step S640 in a case where it has determined that the metadata has not been added.

Processing of steps S630 to S633 is executed with respect to each one of object information pieces that have been added.

In step S630, the CPU 901 checks the type of the added object information; processing is branched to step S631, step S632, and step S633 when the added object information is appearance information, disappearance information, and position update information, respectively.

In step S631, the CPU 901 makes a registration for a reservation of rendering of an object frame corresponding to region information of an object that has appeared. As a result, the object frame is superimposed and displayed on the video.

In step S632, the CPU 901 deletes registration information for a reservation of rendering of an object frame corresponding to region information of an object that has become non-existent. As a result, the object frame is not displayed on the video currently displayed.

In step S633, the CPU 901 updates registration information for a reservation of rendering of an object frame corresponding to region information of an object for which a position update has been made. As a result, the position of the object frame can be displayed in such a manner that it follows the movement of the object.

After entire processing for the object information has been completed, in step S640, the CPU 901 superimposes and displays the object frame (or label) that has been registered/updated in step S631 or S633 on the video decoded in step S610.

In step S650, the CPU 901 checks whether the reception processing has ended; if the reception processing is ongoing, the processing returns to step S600.

In view of the description of the flowcharts of FIG. 5 and FIG. 6, the following describes how the operations are performed when a frame drop has occurred due to a trouble in a communication path at the time of video transmission.

An error caused by a trouble in a communication path at the time of video transmission is detected in step S600, and received frames are skipped until the next I frame in step S601.

Object data of the frame associated with the occurrence of the error and the frames that have been skipped (discarded) in step S601 is not used as a target of processing of steps S630 to S633. Among object information pieces that have been disposed of, disappearance information of an object has been re-transmitted in step S541 on the transmission side. Regarding the re-transmitted disappearance information of the object, the re-transmitted disappearance information of the object is processed in step S632 in connection with an I frame after undergoing step S601, and an object frame is deleted.

As has been described above using FIG. 1 to FIG. 5, transmitting information of an object multiple times can suppress the occurrence of a problem in which a frame of an object that no longer exists is continuously displayed even if a frame drop has occurred.

Also, although the present embodiment has been described specifically with use of an object frame, it is apparent that a similar implementation is possible when the object frame is replaced with a label display.

Furthermore, in a case where a frame that includes object information at the time of update of position information of an object has errored due to a trouble in a communication path, an object frame that remains misplaced is continuously displayed. To address this issue, it is possible to take a supplementary action of adding position information of an object again in a case where the position of the object has not changed over a certain number of frames or more; this is also pursuant to the intent of the present invention. In this case, the position information of the object is written into ar_bounding_box_top and ar_bounding_box_left in an ARSEI message.

Moreover, although the present embodiment adopts a configuration in which object disappearance information is re-transmitted only in connection with an I frame, the present invention is not limited to this. For example, in the case of a long I-frame interval, which is called a LONG GOP, the interval of re-transmission of disappearance information of an object becomes long as well. To address this issue, object disappearance information may be re-transmitted at a constant frame interval, irrespective of whether the frame is an I frame or a P frame. In this case, the receiving side adopts a configuration in which, when skipping frames in step S601, for example, decoding of images is skipped, but ARSEI is detected and processing equivalent to steps S630 to S633 is executed.

### Second Embodiment

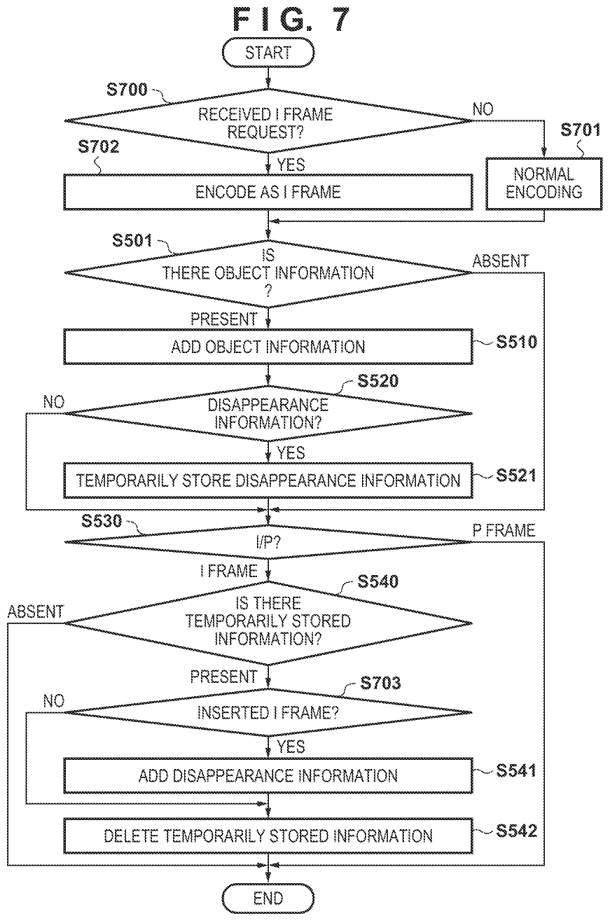

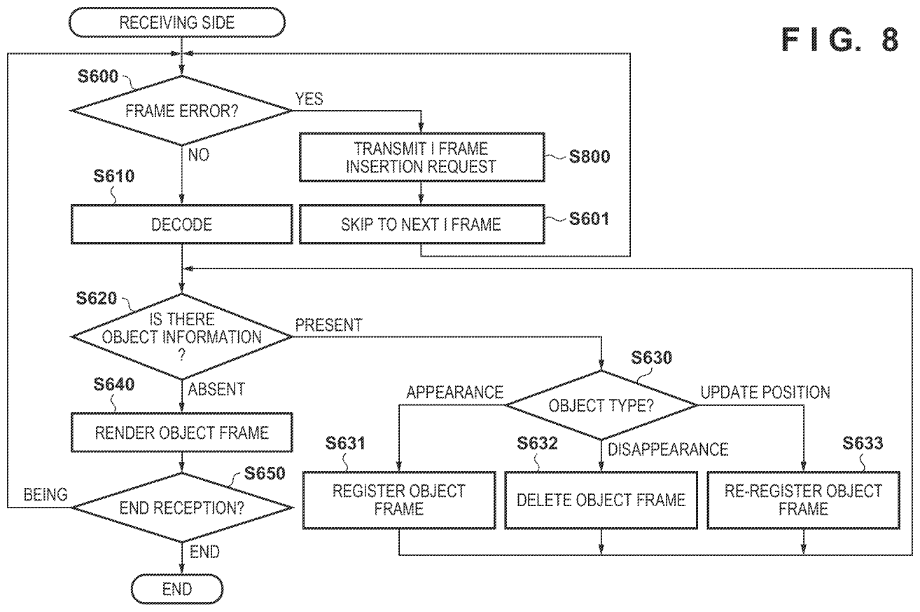

A second embodiment will be described with reference to FIG. 7 and FIG. 8.

FIG. 1 to FIG. 4 and FIG. 9 of the above-described first embodiment are similarly applicable to the present second embodiment, and thus a description thereof is omitted.

FIG. 7 is a flowchart showing a flow of video distribution control of the video distribution apparatus 100 in the second embodiment, which is obtained by changing a part of FIG. 5. Also, FIG. 8 is a flowchart showing a flow of video reception processing of the client apparatus 900, which is obtained by changing a part of FIG. 6.

Processing of the client apparatus 900 in FIG. 8 is different from the first embodiment in that processing of step S800 is added between steps S600 and S601 of FIG. 6, and is the same as the first embodiment in other aspects.

When the CPU 901 of the client apparatus has detected an error in reception processing for a video frame in step S600, processing proceeds to step S800. In this step S800, the CPU 901 transmits an I frame transmission request message to the video distribution apparatus 100, which is the transmission side. While the transmission side normally transmits an I frame at a constant interval, this request can be regarded as instruction information indicating a demand for immediate transmission of an I frame regardless of that interval. The purpose thereof is to reduce the number of frames that are skipped (discarded) in step S601, and also to provide a notification indicating that the error has occurred due to a trouble in a communication path. Furthermore, in this case, the video distribution apparatus 100 permits a plurality of I frames to be included in a corresponding GOP.

Next, processing of the video distribution apparatus 100, which is the transmission side, in FIG. 7 will be described.

Processing of the transmission side in FIG. 7 is different in that step S500 of FIG. 5 is replaced with steps S700 to S702, and that processing of step S703 is added between steps S540 and S541 of FIG. 5, and is the same in other aspects.

In step S700, the CPU 101 of the video distribution apparatus 100 determines whether an I frame transmission request message has been received from the video reception apparatus 900. In a case where the CPU 101 has determined that an I frame transmission request message has not been received, processing proceeds to step S701, and the compression/decompression unit 150 is controlled to encode the current frame as one of an I frame and a P frame in accordance with a cycle indicated by a normal GOP. That is to say, step S701 is the same as step S500 in the first embodiment.

On the other hand, in a case where the CPU 101 has determined that an I frame transmission request message has been received from the video reception apparatus 900 in step S700, processing proceeds to step S702. In this step S702, the CPU 101 controls the compression/decompression unit 150 so that the current frame is forcibly encoded as an I frame. Note, it is assumed that processing proceeds to step S700 also in a case where the current frame happens to coincide with a timing of encoding as an I frame in a normal GOP.

In step S703, the CPU 101 of the video distribution apparatus 100 determines whether the current frame, namely I frame, is derived from normal processing, or corresponds to an I frame insertion request message from the client apparatus 900. Then, in a case where the CPU 101 has determined that the current frame corresponds to an I frame insertion request from the client apparatus 900, processing proceeds to step S541, and object disappearance information is re-transmitted. On the other hand, in a case where the CPU 101 has determined that the current frame is an I frame of normal processing from the client apparatus 900, processing proceeds from step S700 to step S542 (processing of step S541 is skipped).

By adopting the above-described configuration, the present second embodiment can re-transmit object disappearance information only when the receiving side has detected an error; in this way, a traffic increase caused by re-transmission can be minimized. Furthermore, as an I frame is transmitted at an interval shorter than a normal interval, the number of times frames are skipped on the receiving side can be reduced.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A video distribution apparatus including image capturing unit, encoding unit configured to encode video data obtained by the image capturing unit, and communication unit configured to transmit the encoded video data obtained by the encoding unit to a reception apparatus in a network, the video distribution apparatus comprising:
object detection unit configured to execute object detection processing with respect to a video indicated by video data obtained by the image capturing unit;
metadata addition unit configured to add information related to an object obtained by the object detection unit, as metadata, to encoded data of a corresponding frame of the video; and
control unit configured to control the metadata addition unit based on a result of the detection processing executed by the object detection unit,
wherein in a case where the result of the detection processing executed by the object detection unit indicates a disappearance of the object, the control unit controls the metadata addition unit to add metadata indicating the disappearance of the object also to a frame that follows the corresponding frame and satisfies a predetermined condition.

2. The video distribution apparatus according to claim 1, wherein the metadata includes information indicating a position of a rectangular region surrounding the object and a label.

3. The video distribution apparatus according to claim 1, wherein the encoding unit executes encoding processing in units of a Group Of Picture (GOP) that comprises at least one I frame and a plurality of P frames, and
the frame that satisfies the predetermined condition is a first I frame that follows a frame in which the object has disappeared.

4. The video distribution apparatus according to claim 1, wherein, in a case when an I frame transmission request has been received from the reception apparatus, the control unit controls the encoding unit so that a current frame is forcibly encoded as an I frame.

5. A control method for a video distribution apparatus including image capturing unit, encoding unit configured to encode video data obtained by the image capturing unit, and communication unit configured to transmit the encoded video data obtained by the encoding unit to a reception apparatus in a network, the control method comprising:
executing object detection processing with respect to a video indicated by video data obtained by the image capturing unit;
adding information related to an object obtained through the object detection processing, as metadata, to encoded data of a corresponding frame of the video; and
controlling the adding of the metadata based on a result of detection processing in the object detection processing,
wherein in a case where the result of the detection processing in the object detection processing indicates a disappearance of the object, the controlling of the adding of the metadata performs control so that, in the adding of the metadata, metadata indicating the disappearance of the object is added also to a frame that follows the corresponding frame and satisfies a predetermined condition.

6. A non-transitory computer-readable storage medium storing a computer program that causes a computer of a video distribution apparatus to function as follows, the video distribution apparatus including image capturing unit, encoding unit configured to encode video data obtained by the image capturing unit, and communication unit configured to transmit the encoded video data obtained by the encoding unit to a reception apparatus in a network:
object detection unit configured to execute object detection processing with respect to a video indicated by video data obtained by the image capturing unit;
metadata addition unit configured to add information related to an object obtained by the object detection unit, as metadata, to encoded data of a corresponding frame of the video; and
a control unit configured to control the metadata addition unit based on a result of the detection processing executed by the object detection unit,
wherein, in a case when the result of the detection processing executed by the object detection unit indicates a disappearance of the object, the control unit causes the metadata addition unit to function so that metadata indicating the disappearance of the object is added also to a frame that follows the corresponding frame and satisfies a predetermined condition.

7. A video reception apparatus including communication unit configured to receive encoded video data from a video distribution apparatus, and display unit configured to display a video, the video distribution apparatus including:
image capturing unit;
encoding unit configured to encode video data obtained by the image capturing unit;
communication unit configured to transmit the encoded video data obtained by the encoding unit to a reception apparatus in a network;
object detection unit configured to execute object detection processing with respect to a video indicated by the video data obtained by the image capturing unit;
metadata addition unit configured to add information related to an object obtained by the object detection unit, as metadata, to encoded data of a corresponding frame of the video; and
control unit configured to control the metadata addition unit based on a result of the detection processing executed by the object detection unit, wherein in a case where the result of the detection processing executed by the object detection unit indicates a disappearance of the object, the control unit controls the metadata addition unit to add metadata indicating the disappearance of the object also to a frame that follows the corresponding frame and satisfies a predetermined condition,
the video reception apparatus comprising:
decoding unit configured to decode encoded video data received by the communication unit; and
a control unit configured to superimpose and displaying information related to an object according to metadata that has been added to the encoded video data on a video obtained by the decoding unit on the display unit,
wherein, in a case when there is an error in a current frame of the encoded video data received by the communication unit, the control unit discards data preceding a frame that follows the current frame and satisfies a predetermined condition.

8. A control method for a video reception apparatus including communication unit configured to receive encoded video data from a video distribution apparatus, and display unit configured to display a video, the video distribution apparatus including:
image capturing unit;
encoding unit configured to encode video data obtained by the image capturing unit;
communication unit configured to transmit the encoded video data obtained by the encoding unit to a reception apparatus in a network;
object detection unit configured to execute object detection processing with respect to a video indicated by the video data obtained by the image capturing unit;
metadata addition unit configured to add information related to an object obtained by the object detection unit, as metadata, to encoded data of a corresponding frame of the video; and
control unit configured to control the metadata addition unit based on a result of the detection processing executed by the object detection unit, wherein in a case where the result of the detection processing executed by the object detection unit indicates a disappearance of the object, the control unit controls the metadata addition unit to add metadata indicating the disappearance of the object also to a frame that follows the corresponding frame and satisfies a predetermined condition,
the control method for the video reception apparatus comprising:
decoding encoded video data received by the communication unit; and
performing control so that information related to an object according to metadata that has been added to the encoded video data is superimposed and displayed on a video obtained through the decoding on the display unit,
wherein in a case where there is an error in a target frame of the encoded video data received by the communication unit, data preceding a frame that follows the target frame and satisfies a predetermined condition is discarded in the control to superimpose and display.

9. A non-transitory computer-readable storage medium storing a computer program for a computer that controls a video reception apparatus including communication unit configured to receive encoded video data from a video distribution apparatus, and display unit configured to display a video, the video distribution apparatus including:
image capturing unit;
encoding unit configured to encode video data obtained by the image capturing unit;
communication unit configured to transmit the encoded video data obtained by the encoding unit to a reception apparatus in a network;
object detection unit configured to execute object detection processing with respect to a video indicated by the video data obtained by the image capturing unit;
metadata addition unit configured to add information related to an object obtained by the object detection unit, as metadata, to encoded data of a corresponding frame of the video; and
control unit configured to control the metadata addition unit based on a result of the detection processing executed by the object detection unit, wherein in a case where the result of the detection processing executed by the object detection unit indicates a disappearance of the object, the control unit controls the metadata addition unit to add metadata indicating the disappearance of the object also to a frame that follows the corresponding frame and satisfies a predetermined condition,
the computer program causing the computer to function so as to:
decode encoded video data received by the communication unit; and
perform control so that information related to an object according to metadata that has been added to the encoded video data is superimposed and displayed on a video obtained through the decoding on the display unit,
wherein, in a case when there is an error in a target frame of the encoded video data received by the communication unit, the control to superimpose and display is caused to function so that data preceding a frame that follows the target frame and satisfies a predetermined condition is discarded.
